(19) United States
(12) Patent Application Publication
(10) Pub. No.: US 2017/0018068 A1
(43) Pub. Date: Jan. 19, 2017

(54) PROBE DEVICE

(71) Applicant: MPI Corporation, Chu-pei City (TW)

(72) Inventors: Stojan Kanev, Hsinchu County (TW); Chia-hung Hung, Hsinchu County (TW); PING-YU HU, Hsinchu County (TW); YAO-CHUAN CHIANG, Hsinchu County (TW)

(21) Appl. No.: 15/062,273

(22) Filed: Mar. 7, 2016

(30) Foreign Application Priority Data
Jul. 16, 2015 (TW) 104123144

(51) Int. Cl. G06T 7/00; H04N 5/225; H04N 5/247

(52) U.S. Cl. CPC G06T 7/0004; H04N 5/247; H04N 5/2251

(57) ABSTRACT

A probe device includes a case, a fixing base, a probe stage, a first camera and a first mirror. The case includes a bottom plate and a first side wall, which includes a first through hole and is vertically connected to the bottom plate. The fixing base, disposed inside the case, can move along a Z-axis direction. The probe stage, disposed inside the case, is used to carry a probe having a probe tip. The first camera is disposed outside the case and fixed to the first side wall. The first mirror is disposed relative to the first camera with a first angle formed between a surface of the first mirror and the normal line of the first camera. The first mirror can move along the Z-axis direction so that the first camera captures images of the probe tip through the first through hole via the first mirror.

### CROSS-REFERENCES TO RELATED APPLICATIONS

This non-provisional application claims priority under 35 U.S.C. §119(a) on Patent Application No. 104123144 filed in Taiwan, R.O.C. on 2015 Jul. 16, the entire contents of which are hereby incorporated by reference.

### BACKGROUND

Technical Field

The instant disclosure relates to a probe device, in particular, of which probe tip can make accurate contacts on inspected surfaces by observing through a movable camera module.

Related Art

Conventionally, wafers serve as a substrate on which integrated circuits (IC) are fabricated. As a wafer diameter becomes larger, the number of integrated circuits produced on a wafer can be increased. Thus, integrated circuits are typically fabricated on wafers in a batch, by having the wafers going through many manufacturing process steps, such as photolithography, deposition, diffusion etc. and then are diced into small rectangular pieces. Such a small piece, singulated from a wafer, can be called a die.

In general practice, largely due to physical defects of a wafer itself and/or defects arising during the wafer processing, some of the dies may encounter some adverse problems later on. In order to identify the defective dies on wafers before dicing, wafer inspection systems or probe devices are used to help detect the defects. One of the detection methods is using a fixing base to move the wafer so that electrode regions on various integrated circuit layouts over the wafer, which resides on the fixing base, can be contacted by a probe, carried by a fixed probe stage, for electrical inspection.

However, since thickness of each wafer may vary, or each probe has different length, due to its original length or being worn out, this causes that the probe cannot make accurate and solid contacts with the electrode regions of various integrated circuit layouts. Therefore, how to make sure the probe is positioned properly to make accurate contacts with the inspected surface of inspected objects indeed is an important task for those in the art to work on.

### SUMMARY

In view of these, an embodiment of a probe device of the instant disclosure includes a case, a fixed base, a probe stage, a first camera and a first mirror. The case includes a bottom plate and at least one first side wall. A first side wall has a first through hole, and is vertically connected to the bottom plate. A fixing base is disposed inside the case, and is movable along a Z-axis direction. A probe stage is disposed inside the case and carries a probe having a probe tip. A first camera is disposed outside the case and fixed to the first side wall. A first mirror is disposed relative to the first mirror, with a first angle formed between the first mirror and the normal line of the first camera; wherein the first mirror is capable of moving along the Z-axis direction so that the first camera captures images of the probe tip through the first through hole via the first mirror.

Another embodiment of a probe device of the instant disclosure includes a case, a fixed base, a probe stage, a first camera and a first mirror. The case includes a bottom plate, a top plate, a first side wall and a second side wall. The first side wall is vertically connected to one side of the bottom plate and has a first through hole. The second side wall is perpendicular to the first side wall and the bottom plate, respectively. The top plate can be lifted, hinged at one side of the second side wall. The fixing base is disposed inside the case, and is movable along the Z-axis direction. A probe stage is disposed inside the case, and in particular between the fixing base and the top plate and is used to carry a probe having a probe tip. The first camera is disposed outside the case, and fixed to the top plate. The first mirror is disposed relative to the first camera with a first angle formed between a surface of the first mirror and the normal line of the first camera. The first mirror is capable of moving in the Z-axis direction so that the first camera captures images of the probe tip through the first through hole via the first mirror.

In summary, according to an example of a probe device of the instant disclosure, the imaging assembly which is capable of moving in the Z-axis direction, perpendicular to a direction of the inspected surface can observe, from the side of the inspected object, the contact situation between the probe and the inspected object. Accordingly, the fixing base can be adjusted. Until the tip of the probe image of the probe is just in contact with that of the mapping image mapped in the image, the probe tip of the probe can be affirmed to be substantially in contact with the inspected surface of the inspected object, residing on the fixing base.

Additional features and advantages are set forth in the Detailed Description that follows, and in part will be readily apparent to those skilled in the art from the description or recognized by practicing the embodiments as described in the written description and claims hereof, as well as the appended drawings. And the purposes and the advantages of the instant disclosure should be readily understood by any who is skilled in the art from the descriptions, claims and drawings in the instant disclosure.

### BRIEF DESCRIPTION OF THE DRAWINGS

The accompanying drawings are included to provide a further understanding and are incorporated in and constitute a part of this specification. The drawings illustrate one or more embodiment(s), and together with the Detailed Description serve to explain principles and operation of the various embodiments. As such, the instant disclosure will become more fully understood from the following Detailed Description, taken in conjunction with the accompanying Figures, in which:

FIG. 1 is a cross-sectional schematic diagram of an embodiment of a probe device according to the instant disclosure;

FIG. 2 is a top-down view of an embodiment of an embodiment of a probe device according to the instant disclosure;

FIG. 3 is a cross-sectional schematic diagram of another embodiment of a probe device according to the instant disclosure;

FIG. 4 is a cross-sectional schematic diagram of another embodiment of a probe device according to the instant disclosure;

FIG. 5 is a top-down view of another embodiment of an embodiment of a probe device according to the instant disclosures;

FIG. 6 is a cross-sectional schematic diagram of another embodiment of FIG. 5;

FIG. 7 is a cross-sectional schematic diagram of another embodiment of a probe device according to the instant disclosure;

FIG. 8 is a cross-sectional schematic diagram of another embodiment of FIG. 7;

FIG. 9 is a schematic diagram that shows a camera device captures an image; and

FIG. 10 is a schematic diagram that shows a camera device captures an image.

### DETAILED DESCRIPTION

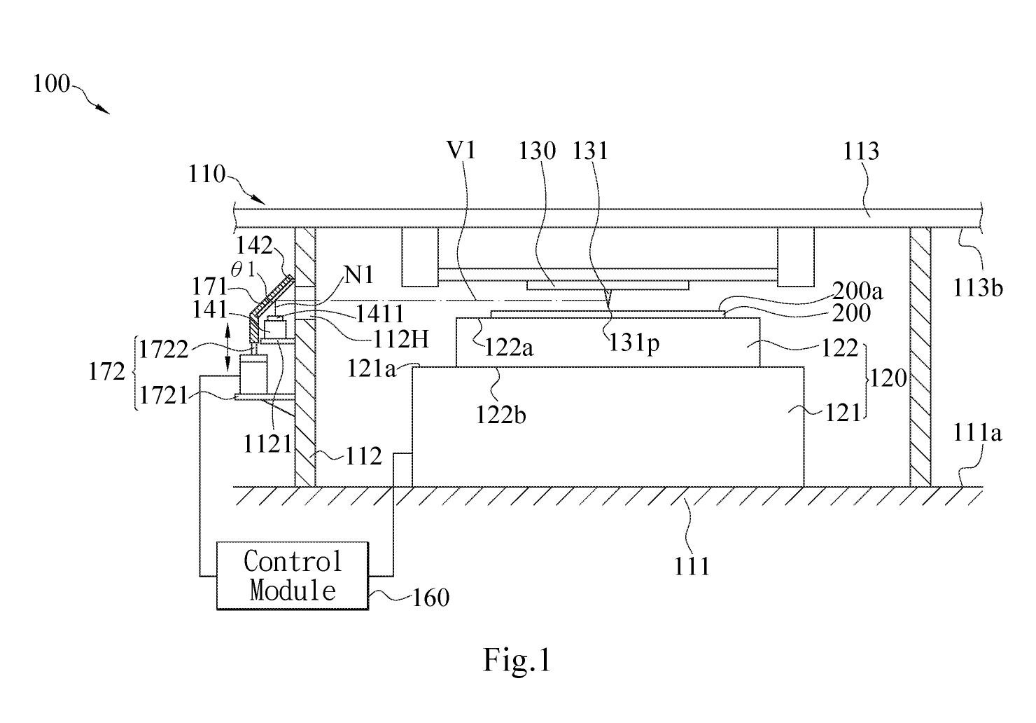

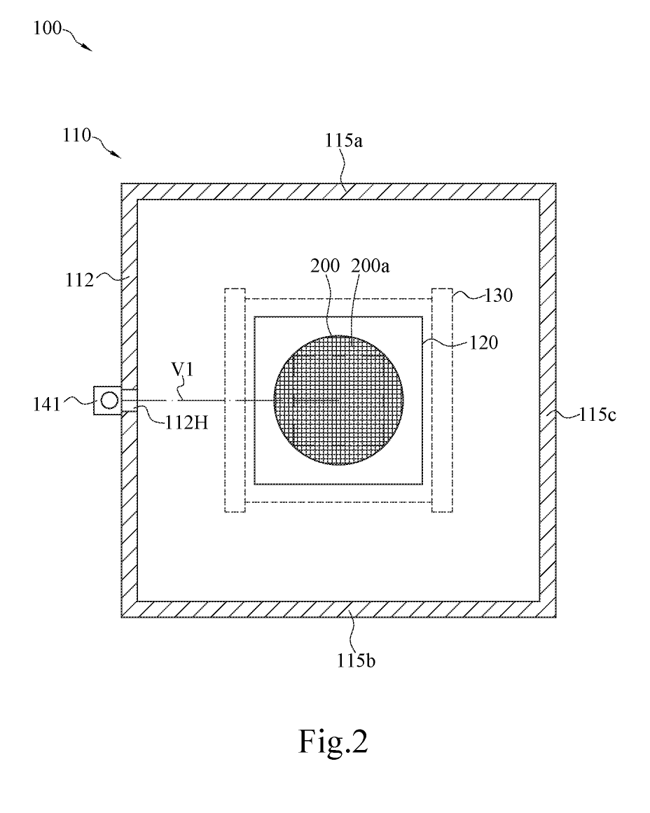

FIG. 1 is a cross-sectional schematic diagram of an embodiment of a probe device according to the instant disclosure. FIG. 2 is a top-down view of an embodiment of a probe device according to the instant disclosure. Please refer to FIG. 1 and FIG. 2, which disclose a probe device 100, used to inspect an inspected object 200. As such, an inspected object 200 can be a wafer, on which a number of integrated circuit chips are fabricated. However, this disclosure is not limited thereto; an inspected object 200 can also be a die or a printed circuit board etc. An embodiment of a probe device 100 of this disclosure includes a case 110, a fixing base 120, a probe stage 130, a first camera 141 and a first mirror 142, wherein a fixing base 120 and a probe stage 130 are disposed inside the case 110, and a first camera 141 and a first mirror 142 are disposed outside the case 110.

The case 110 include a bottom plate 111 and at least a first side wall 112. Below, a first side wall 112 is taken as an example for the sake of explanation, but the instant disclosure is not limited thereto. As such, the first side wall 112 is connected to one side of the bottom plate 111 and is perpendicular to the bottom plate 111. In the present embodiment, the case 110 forms a hollow rectangular body, and therefore, the case 110 further includes a top plate 113 and third side walls 115a-115c to form a housing space.

Herein, the third side walls 115a-115b are perpendicularly connected to the two sides of the first side wall 112, respectively, and are vertically connected to the bottom plate 111, respectively. The two sides of the third side wall 115c are perpendicularly connected to the third side walls, 115a-115b, and the third side wall 115c is perpendicular to the bottom plate 111. The top plate 113 is connected to one side of the third side wall 115a and the top plate 113 can be connected to one side of the third side wall 115a by way of a shaft to turn. In other words, the top plate 113 can be lifted, connected to one side of the third side wall 115a.

In addition, the first side wall 112 has a first through hole 112H to provide the first camera 141 to observe the internal state of the case 110. Herein, the first through hole 112H is substantially rectangular, wherein the length and/or width of the first through hole 112H can be approximately 40 mm. However, the instant disclosure is not limited thereto, the first through hole 112H can also be circular, wherein the diameter of the first through hole 112H can be approximately 30 mm.

A fixing base 120 is roughly cylindrical and is disposed in the housing space of the case 110. In this embodiment, the fixing base 120 can include a movable stage 121 and a chuck 122. A chuck 122 is used to fix an inspected object 200 in order to prevent the inspected object 200 from being displaced arbitrarily due to external disturbances. A chuck 122 has an upper surface 122a and a lower surface 122b, wherein the upper surface 122a of the chuck 122 is used to support the inspected object 200. Here, the chuck 122 can fix the inspected object 200 on the upper surface 122a by suction effect.

A movable stage 121 is disposed on the bottom plate 111, wherein the upper surface 121a to support the chuck 122. The movable stage 121 can be coupled to a control module 160 to move along the inspected objects 200 on the X-Y plane (i.e., above upper surface 111a of the bottom plate 111) according to control signals from the control module 160. In addition, the movable stage 121 can also move the inspected objects 200 along a Z-axis direction according to control signals from the control module 160. In this embodiment, the control module 160 can adjust the movement of the movable stage 121 of the fixing base 120 along the Z-axis direction according to a first image captured by the first camera 141 through the first through hole 112H via the first mirror.

Herein, the inspected object 200 has an inspected surface 200a, which is substantially parallel to the bottom plate 111, and the Z-axis is perpendicular to the inspected surface 200a of the inspected object 200.

A probe stage 130 is used to carry a probe 131 having a probe tip 131p. In this embodiment, the probe stage 130 is disposed inside the housing space of the case 110 and is disposed on the lower surface 113b of the top plate 113, and in particular is disposed between the top plate 113 and the fixing base 120. Herein, for ease of illustration, only a probe 131 is illustrated, but the number of probes 131 which the probe stage 130 carries can be more than one and is not limited thereto.

In addition, the probe 131 may be any type of probes, e.g., a needle probe, a spring probe and the like. However, the selection of the probe 131 material is generally determined by the material of the inspected object 200. Therefore, the probe 131 may be made of tungsten (W), beryllium copper (BeCu) and palladium (Pd) alloy or the like.

In general, there is a gap between the probe 131 on the probe stage 130 and the inspected object 200, which allows the fixing base 120 to move along the inspected object 200 on the X-Y plane, and at the same time to prevent scratching the inspected object 200 with the probe 131, or damaging the probe 131.

Since the inspected object 200, which is disposed in the housing space of the case 110, may still need to go through temperature test or other tests related to environmental factors, the first camera 141 and the first mirror 142 are preferably disposed outside the case 110.

In this embodiment, the first camera 141 can be fixed to the first side wall 112 by being disposed on the support arm 1121 of the first side wall 112. The first camera 141 can be used to capture images of the probe tip 131P of the probe 131, disposed inside the case 110, and the inspected object 200 from the first through hole 112H of the first sidewall 112, wherein the lens 1411 of the first camera 141 is substantially parallel to the bottom plate 111 and/or the inspected surface 200a. And the first mirror 142 has a reflecting surface and is disposed relative to the first camera 141, with the reflecting surface facing toward the first camera 141 and forming a first angle θ1 from the normal line N1 of the first camera 141. Herein, the normal line N1 of the first camera 141 can be the Z-axis direction, mentioned above.

Thus, as shown in FIG. 1, the observation axis V1 of the first camera 141 goes through the first through hole 112H of the first sidewall 112 after being reflected by the first mirror 142. In other words, a first image, captured by the first camera 141, is what is reflected by the first mirror 142. Herein, the first angle θ1 can be 45°, and therefore, the observation axis V1 of the first camera 141 is substantially parallel to the bottom plate 111 and/or the inspected surface 200a after being reflected via the first mirror 142.

In the present embodiment, the first mirror 142 can move relative to the first camera 141 along the Z-axis direction to change the imaging magnification of the first camera 141, so that the image of the tip 131p of the probe 131 in the first image, captured by the first camera 141, can be of appropriate size.

Thus, the probe device 100 further includes a first connection part 171 and a first shift structure 172. As shown in FIG. 1, a first connection part 171 is connected to the first mirror 142, and the first shift structure 172 is connected to the first connection part 171, so that the first mirror 142, connected to the first connection part 171, can be moved by the shift adjustment mechanism of the first shift structure 172.

The first shift structure 172 includes a first fixed part 1721 and a first stretching part 1722, The first fixing part 1721 is connected to the first side wall 112 so that the first shift structure 172 can be stably disposed on the first side wall 112. The first stretching part 1722, connected to the first fixed part 1721 and the first connection part 171, serves to assist the movement of the first mirror 142 along the Z-axis direction. Herein, by way of the adjustment in the Z-axis direction of the first stretching part 1722, the first mirror 142 can move with respect to the fixed first camera 141. In other words, during the moving process of the first mirror 142, the relative distance between the first mirror 142 and the first camera 141 will change, hereby to change the imaging magnification of the first camera 141.

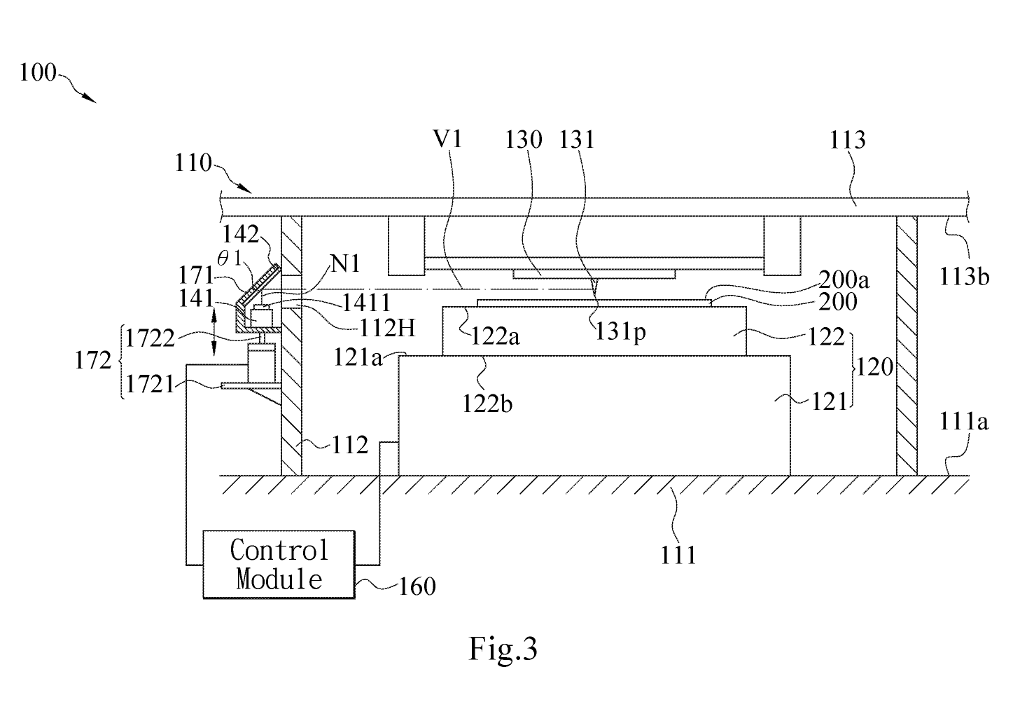

FIG. 3 is a cross-sectional schematic diagram of another embodiment of an example probe device according to the instant disclosure. In another exemplary embodiment according to the instant disclosure, the first camera 141, as the first mirror 142, can be moved in the Z-axis direction so that the first camera 141 can capture images of the tip 131p of the probe 131 by way of the reflection of the first mirror 142 through the first through hole 112H.

Thus, in this embodiment, the probe device 100 further includes a first connection part 171 and the first shift structure 172. Wherein the first connection part 171 is connected to the first mirror 142 and the first camera 141, and the first shift structure 172 is connected to the first connection part 171 so that the first mirror 142, connected to the first connection part 171, and the first camera 141 can be moved in the Z-axis direction by the shift adjustment mechanism of the first shift structure 172.

Herein, the first shift structure 172 includes a first fixed part 1721 and a first stretching part 1722. The first fixed part 1721 is fixed to the first side wall 112, and is used to assist the first mirror 142 and the first camera 141, which are connected to the first connection part 171, to be securely disposed on the first side wall 112. The first stretching part 1722, connected to the first fixed part 1721 and the first connection part 171, is used to assist the movement of the first mirror 142 and the first camera 141 in the Z-axis direction.

In the present embodiment, the first mirror 142 and the first camera 141 move by way of the adjustment of the first stretching part 1722 in the Z-axis direction simultaneously. In other words, during the moving process of the first mirror 142, the relative distance between the first mirror 142 and the first camera 141 will not change. Thus, the first shift structure 172 can move the first mirror 142 and the first camera 141 in the Z-axis direction by way of the adjustment of the first stretching part 1722, hereby to make the tip 131p of the probe 131 be located along the observation axis V1 of the first camera 141.

In addition, the first stretching part 1722 can be coupled to a control module 160 to move the first mirror 142 in the Z-axis direction according to the control signal of the control module 160, or to move the first mirror 142 and the first camera 141 together in the Z-axis direction. Herein, the control module 160 can generate a corresponding control signal according to a first image captured by the first camera 141 through the first through hole 112H, so that the first stretching part 1722 of the first shift structure 172 can be adjusted according to the control signal correspondingly. Thus, in all embodiments of the instant disclosure, the first stretching part 1722 can be a combination of a rail and a motor.

In the present embodiment, the aforementioned first camera 141 can be a camera, a video camera, or a CCD (charge-coupled device) camera or the like. In addition, during the moving process of the first camera 141, it can take continuous photo shots or record a video to identify the position of the tip 131p of the probe 131 in the Z-axis direction by visual recognition. Wherein the visual recognition or the moving of the first camera 141 can all be performed manually; however, the instant disclosure is not limited thereto. The visual recognition or the moving of the first camera 141 can also be programed by firmware with related devices to achieve automatic identification and corresponding adjustment.

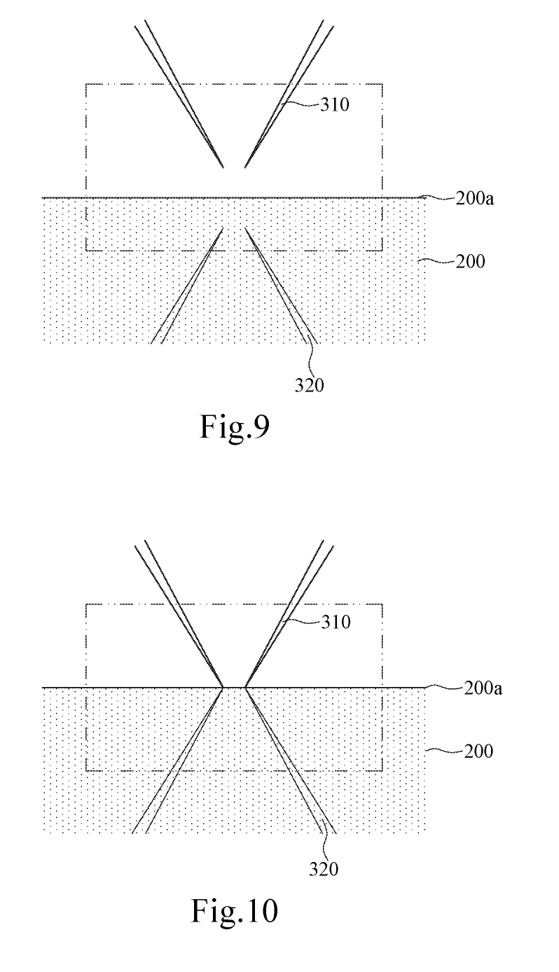

Further, a large-scale backlight (not shown) can be disposed inside the case 110 of the probe device 100 to provide sufficient light for the aforementioned first camera 141 to capture images through the first through hole 112H inside the case 110. In addition, with such backlight illumination, some of the probes 131 can also have the mapping images mapped on the inspected surface 200a of the inspected object 200, as shown on FIG. 9 and FIG. 10. Herein the image of the probe 131 in the imaging picture can be called as a probe image 310 while the mapping image mapped in the image picture can be called as a mapping image 320.

Thus, in an embodiment of a probe device 100 of the instant disclosure, the observation of the probe 131 contacting the inspected object 200 can be performed by way of the first camera 141, disposed outside the case 110, and by way of first shift structure 172 to assist in adjusting the movement of the first mirror 142 and the first camera 141 along the Z-axis direction, hereby to readily adjust the corresponding position of the inspected object 200 in the Z-axis direction. It is until the tip of the probe image 310 of the probe 131 in the first image is substantially in contact with that of the mapping image 320 mapped in the image, the probe tip 131p of the probe 131 is affirmed to be indeed in contact with the inspected surface 200a of the inspected object 200, as shown in FIG. 10.

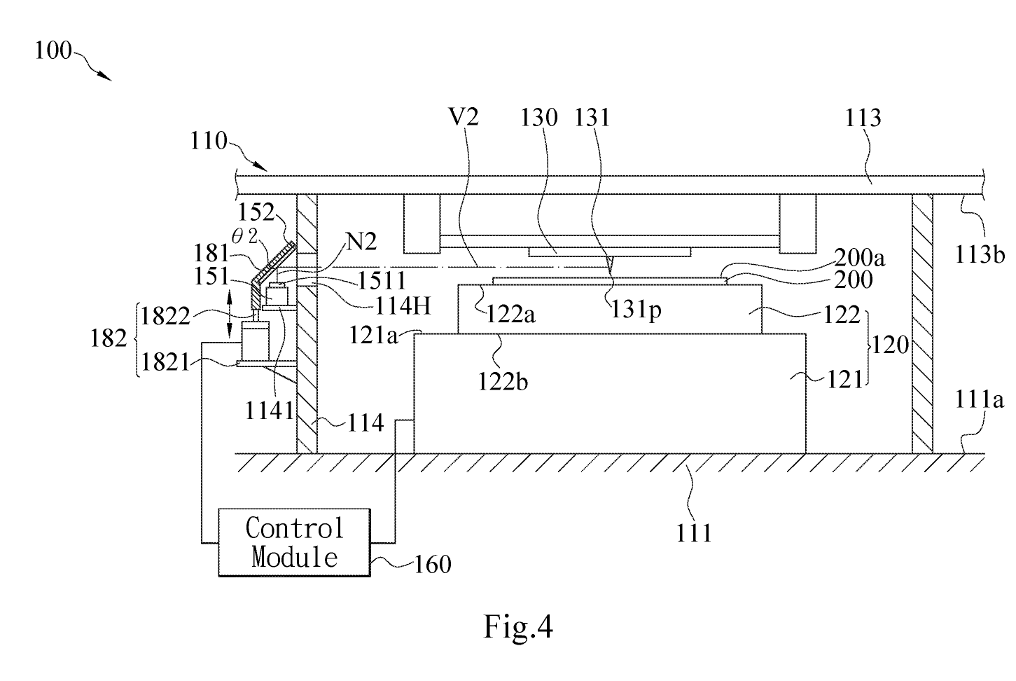

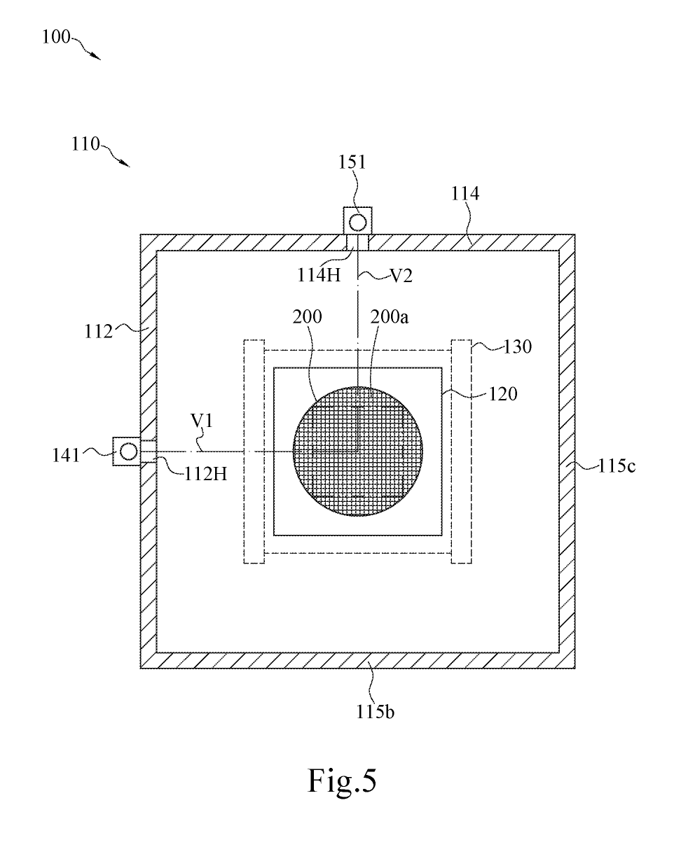

FIG. 4 is a cross-sectional schematic diagram of another embodiment of an example probe device according to the instant disclosure, and FIG. 5 is a top-down view of another embodiment of an example probe device according to the instant disclosures. Please refer to FIGS. 4 and 5, in another embodiment of a probe device 100, a case 110 not only includes a bottom plate 111 and at least one first side wall 112, but further includes a second side wall 114. The second side wall 114 is perpendicularly connected to one side of the first side wall 112 and vertically to the bottom plate 111. Herein a substantially rectangular case 110 is taken as an example; therefore, the case 110 further includes a top plate 113 and third side walls 115a, 115b to form a housing space together with the bottom plate 111, the first side wall 112 and the second side wall 114.

In the present embodiment, the probe device 100 further includes a second camera 151 and a second mirror 152, and the second side wall 114 has a second through hole 114H. Wherein the second through hole 114H is to provide the second camera 151 to observe the internal state of the case 110 through second mirror 152. Herein, the second through hole 114H is substantially rectangular, wherein the length and/or width of the second through hole 114H can be approximately 40 mm. However, the instant disclosure is not limited thereto, the second through hole 114H can also be circular, wherein the diameter of the second through hole 114H can be approximately 30 mm.

The second camera 151 and the second mirror 152 are preferably disposed outside the case 110. Herein, the lens 1511 of the second camera 1511 is substantially parallel to the bottom plate 111 and/or the inspected surface 200a. And the second mirror 152 has a reflecting surface, and the second mirror 152 is disposed relative to the second camera 151, with the reflecting surface facing toward the second camera 151 and forming a second angle θ2 from the normal line N2 of the second camera 151. Herein, the normal line N2 of the second camera 151 can be the Z-axis direction mentioned above.

Thus, as shown in FIG. 4, the observation axis V2 of the second camera 151 goes through the second through hole 114H of the second sidewall 114 after being reflected by the second mirror 152. In other words, a second image, captured by the second camera 151, is via being reflected by the second mirror 152. Herein, the second angle θ2 can be 45°, and therefore, the observation axis V2 of the second camera 151 is substantially parallel to the bottom plate 111 and/or the inspected surface 200a via the reflection of the second mirror 152. In addition, as shown in FIG. 5, since the second camera 151 captures the second image via the second through hole 114H of the second side wall 114, the first camera 141 captures the first image via the first through hole 112H of the second side wall 112, and the second side wall 114 is perpendicular to the first side wall 112, the observation axis V2 of the second camera 151 is substantially orthogonal to the observation axis V1 of the first camera 141.

Refer again to FIG. 4, a probe device 100 further includes a second connection part 181 and a second shift structure 182. In this embodiment, the second camera 151 can be fixed to the second side wall 114 by being disposed on the support arm 1141 of the second side wall 114. The second connection part 181 is connected to the second mirror 152, and the second shift structure 182 is connected to the second connection part 181, so that the second mirror 152, connected to the second connection part 181, can be moved by the shift adjustment mechanism of the second shift structure 182.

The second shift structure 182 includes a second fixed part 1821 and a second stretching part 1822. The second fixing part 1821 is connected to the second side wall 114 so that the second shift structure 182 can be stably disposed on the second side wall 114. The second stretching part 1822, connected to the second fixed part 1821 and the second connection part 181, serves to assist the movement of the second mirror 152 along the Z-axis direction. Herein, by way of the adjustment in the Z-axis direction of the second stretching part 1822, the second mirror 152 can move with respect to the fixed second camera 151. In other words, during the moving process of the second mirror 152, the relative distance between the second mirror 152 and the second camera 151 will change, hereby to change the imaging magnification of the second camera 151.

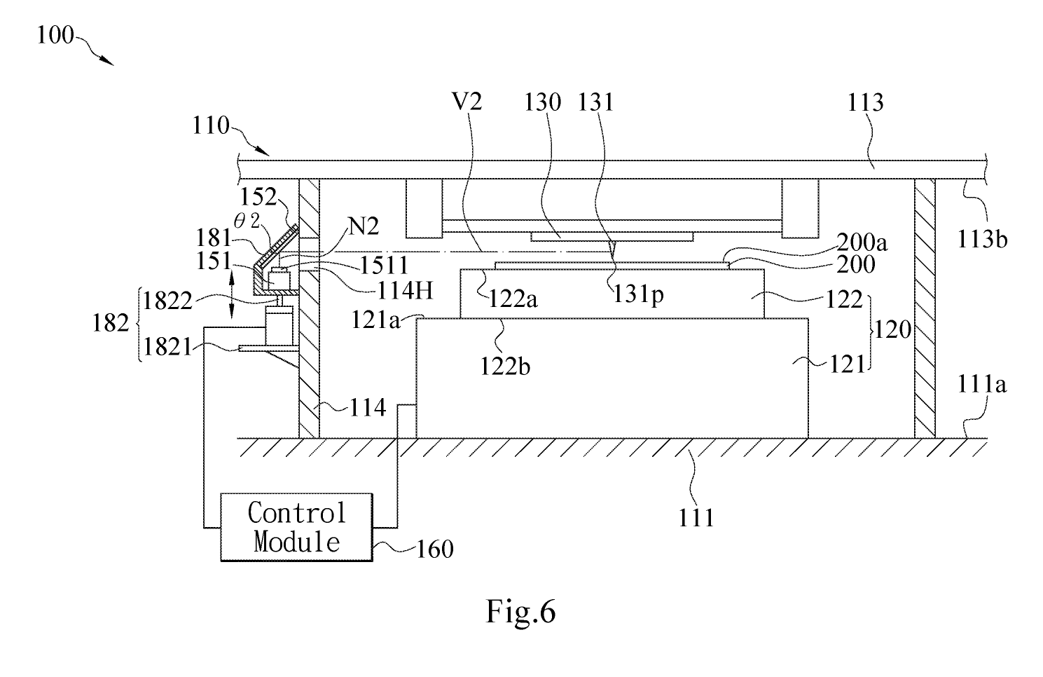

However, in another embodiment, the second camera 151 can also move along the Z-axis direction as a second mirror 152, so that the second camera 151 can capture the image of the probe tip 131p of the probe 131 through the second through hold 114H by the reflection of the second mirror 152. Therefore, with reference to FIG. 6, the second connection part 181 can be connected to the second mirror 152 and the second camera 151. The second fixed part 1821 of the second shift structure 182 is fixed to the second side wall 114, and is used to assist the second mirror 152 and the second camera 151, which are connected to the second connection part 181, to be securely disposed on the second wall 114. The second stretching part 1822 is used to assist the movement of the second mirror 152 and the second camera 151 in the Z-axis direction.

Herein, the second camera system 151 and the second mirror 152 move by way of the adjustment of the second stretching part 1822 in the Z-axis direction simultaneously. In other words, during the moving process, the relative distance between the second camera 151 and the second mirror 152 will not change. Thus, the second shift structure 182 can move the second camera 151 in the Z-axis direction by way of the adjustment of the second stretching part 1822, hereby to make the tip 131p of the probe 131 be located along the observation axis V2 of the second camera 151.

In addition, the second stretching part 1822 can be coupled to a control module 160 to move the second mirror 152 in the Z-axis direction according to the control signal of the control module 160. Herein, the control module 160 can generate a corresponding control signal according to a second image captured by the second camera 151 through the second through hole 114H, so that the second stretching part 1822 of the second shift structure 182 can be adjusted according to the control signal correspondingly. Thus, in all embodiments of the instant disclosure, the second stretching part 1822 can also be a combination of a rail and a motor.

Herein, the second camera 151 is substantially the same as the first camera 141 so the second camera 151 can be a camera, a video camera, or a CCD (charge-coupled device) camera or the like. In addition, during the moving process of the second camera 151, it can take continuous photo shots or record a video to identify the position of the tip 131p of the probe 131 in the Z-axis direction by visual recognition. Wherein the visual recognition or the moving of the second camera 151 can all be performed manually; however, the instant disclosure is not limited thereto. The visual recognition or the moving of the second camera 151 can also be programed by firmware with related devices to achieve automatic identification and corresponding adjustment.

Thus, in another embodiment of a probe device 100 of the instant disclosure, in addition to that the observation of the probe 131 contacting the inspected object 200 can be performed by way of the first camera 141, disposed outside the case 110, the observation of the probe 131 contacting the inspected object 200 can also be performed by way of the second camera 151, disposed outside the case 110, with the better accuracy achieved. Wherein, similarly, the second camera 151 by way of the second shift structure 182 can assist in adjusting the movement of the second mirror 152 and the second camera 151 along the Z-axis direction, hereby to readily adjust the corresponding position of the inspected object 200 in the Z-axis direction. It is until the tip of the probe image 310 of the probe 131 in the second image is substantially in contact with that of the mapping image 320 mapped in the image, the probe tip 131p of the probe 131 is affirmed to be indeed in contact with the inspected surface 200a of the inspected object 200, as shown in FIG. 10.

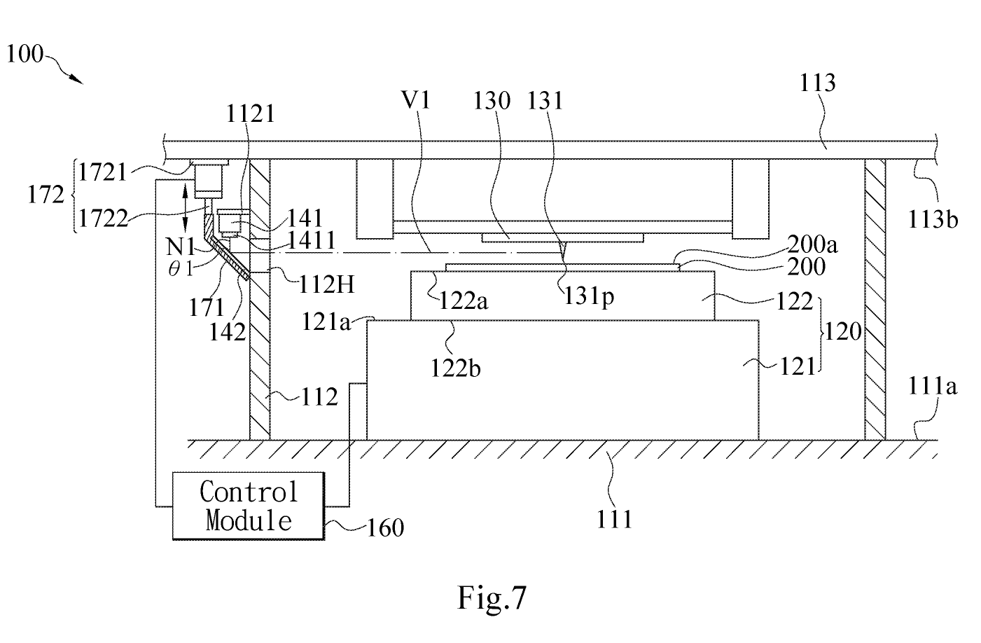

FIG. 7 is a cross-sectional schematic diagram of another embodiment of an example probe device according to the instant disclosure. Refer to FIG. 2 and FIG. 7. Another embodiment of a probe device 100 of the instant disclosure includes a case 110, a fixing base 120, a probe stage 130, a first camera 141 and a first mirror 142. The fixing base 120 and the probe stage 130 are disposed inside the case 110, and the first camera 141 and the first mirror 142 are disposed outside the case 110.

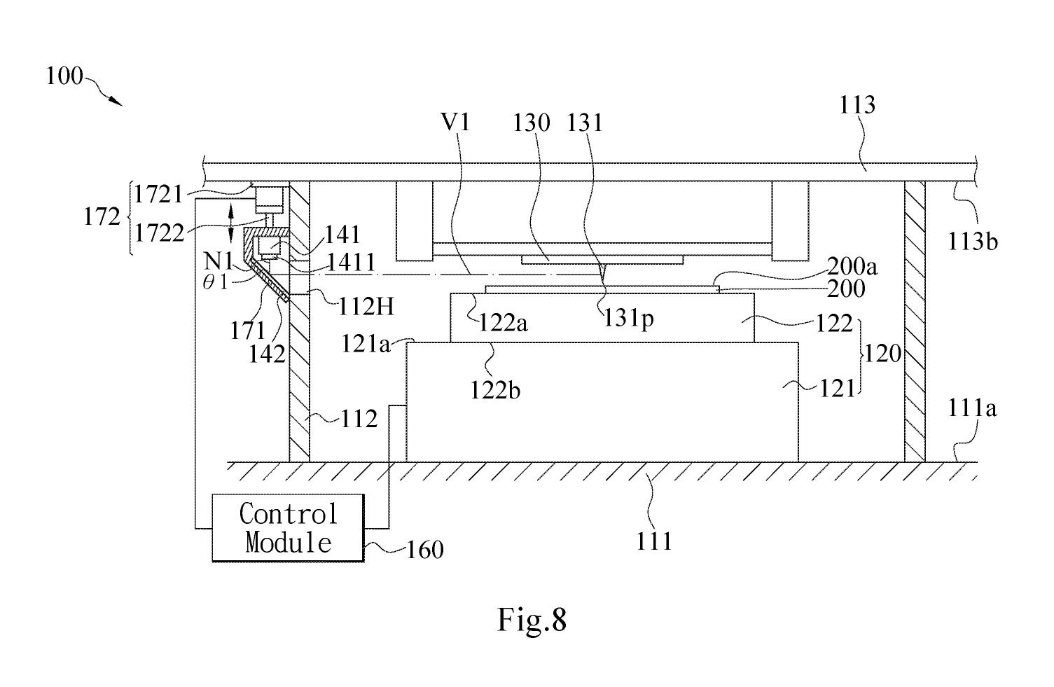

In this present embodiment, the case 110, the fixing base 120 and the probe stage 130 are substantially the same as the embodiments described above, so it will not be repeated here. The structures of the first camera 141 and the first mirror 142 of the present embodiment are also substantially the same as in the embodiments described above, but in this embodiment the first mirror 142 is fixed to the top plate 113 beneath the surface 113b. Thus, in the present embodiment, the first fixing part 1721 of the first shift structure 172, which moves the first mirror 142, is connected to the top plate 113 beneath the surface 113b, so that the first shift structure 172 and the first mirror 142 can be securely disposed beneath the top plate 113. With reference to FIG. 8, in the same manner, as described above, in another embodiment of the instant disclosure, the first connection part 171 can be connected to the first camera 141 and the first mirror 142, and the first stretching part 1722 of the first shift structure 172, which is fixed to the top plate 113, is connected to the first connection part 171 to move the first camera 141 and the first mirror 142 simultaneously.

Furthermore, in still another embodiment of this embodiment, the structures of the second camera 151 and the second mirror 152 are also substantially the same as in the embodiment described above, but in this embodiment the second mirror 152 is fixed to the top plate 113 beneath the surface 113b. Thus, in the present embodiment, the second fixing part 1821 of the second shift structure 182, which moves the second mirror 152, is connected to the top plate 113 beneath the surface 113b, so that the second shift structure 182 and the second mirror 152 can be securely disposed beneath the top plate 113. In the same manner, as described above, the second connection part 181 can be connected to the second camera 151 and the second mirror 152, and the second stretching part 1822 of the second shift structure 182, which is fixed to the top plate 113, is connected to the second connection part 181 to move the second camera 151 and the second mirror 152 simultaneously.

In summary, according to an example of a probe device of the instant disclosure, the imaging assembly is capable of moving in the Z-axis direction, perpendicular to a direction of the inspected surface can observe, from the viewing axis parallel to the wafer, the contact situation between the probe and the inspected object. Accordingly, the fixing base can be adjusted. Until the tip of the probe image of the probe is just in contact with that of the mapping image mapped in the image, the probe tip of the probe can be affirmed to be substantially in contact with the inspected surface of the inspected object, residing on the fixing base.

While the instant disclosure has been described by way of example and in terms of the preferred embodiments, it is to be understood that the invention needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. A probe device, comprising:
a case, comprising a bottom plate and at least one first side wall, wherein the first side wall is vertically connected to the bottom plate and has a first through hole;
a fixing base, which is disposed inside the case and is movable along a Z-axis direction;
a probe stage, disposed inside the case and carrying a probe having a probe tip;
a first camera, disposed outside the case and fixed to the first side wall; and
a first mirror, which is disposed relative to the first mirror, with a first angle formed between a surface of the first mirror and the normal line of the first camera;
wherein the first mirror is capable of moving along the Z-axis direction so that the first camera captures images of the probe tip through the first through hole via the first mirror.

2. The probe device according to claim 1, further comprising:
a first connection part, connected to the first mirror; and
a first shift structure, including a first fixed part and a first stretching part, wherein the first fixed part is fixed to the first side wall and the first stretching part is connected to the first fixed part and the first connection part, so that the first shift structure is capable of moving the first mirror along the Z-axis direction by adjusting the first stretching part.

3. The probe device according to claim 2, further comprising:
a control module, coupled to the fixing base and the first shift structure, the control module adjusting the movement of the fixing base along the Z-axis direction according to a first image captured by the first camera through the first through hole, and/or adjusting the first shift structure to move the first mirror along the Z-axis direction.

4. The probe device according to claim 1, wherein the first camera is capable of moving along the Z-axis direction, the probe device further comprising:
a first connection part, connected to the first mirror and the first camera; and
a first shift structure, including a first fixed part and a first stretching part, wherein the first fixed part is fixed to the first side wall and the first stretching part is connected to the first fixed part and the first connection part, so that the first shift structure is capable of moving the first mirror and the first camera along the Z-axis direction by adjusting the first stretching part.

5. The probe device according to claim 4, further comprising:
a control module, coupled to the fixing base and the first shift structure, the control module adjusting the movement of the fixing base along the Z-axis direction according to a first image captured by the first camera through the first through hole, and/or adjusting the first shift structure to move the first mirror and the first camera along the Z-axis direction.

6. The probe device according to claim 1, further comprising:
a second side wall, perpendicularly connected to one side of the first side wall, vertically connected to the bottom plate and having a second through hole;
a second camera, disposed outside the case and fixed to the second side wall; and
a second mirror, which is disposed relative to the second camera, with a second angle formed between a surface of the second mirror and the normal line of the second camera;
wherein the second mirror is capable of moving along the Z-axis direction so that the second camera captures images of the probe tip through the second through hole via the second mirror.

7. The probe device according to claim 6, further comprising:
a second connection part, connected to the second mirror; and
a second shift structure, including a second fixed part and a second stretching part, wherein the second fixed part is fixed to the second side wall and the second stretching part is connected to the second fixed part and the second connection part, so that the second shift structure is capable of moving the second mirror along the Z-axis direction by adjusting the second stretching part.

8. The probe device according to claim 6, wherein the second camera, which is capable of moving along the Z-axis direction, the probe device further comprising:
a second connection part, connected to the second mirror and the second camera; and
a second shift structure, including a second fixed part and a second stretching part, wherein the second fixed part is fixed to the second side wall and the second stretching part is connected to the second fixed part and the second connection part, so that the second shift structure is capable of moving the second mirror and the second camera along the Z-axis direction by adjusting the second stretching part.

9. A probe device, comprising:
a case, which includes a bottom plate, a top plate, a first side wall and a second side wall, wherein the first side wall is vertically connected to one side of the bottom plate and has a first through hole, and a second side wall is perpendicularly connected to the first side wall and the bottom plate, respectively, and wherein the top plate, hinged at one side of the second side wall, can be lifted;
a fixing base, which is disposed inside the case and is movable along a Z-axis direction;
a probe stage, disposed inside the case and in particular between the fixing base and the top plate and carrying a probe having a probe tip;
a first camera, disposed outside the case and fixed to the top plate; and
a first mirror, disposed relative to a first camera, wherein a first angle is formed between a surface of the first mirror and the normal line of the first camera;
wherein the first mirror is capable of moving along the Z-axis direction so that the first camera captures images of the probe tip through the first through hole via the first mirror.

10. The probe device according to claim 9, further comprising:
a first connection part, connected to the first mirror; and
a first shift structure, including a first fixed part and a first stretching part, wherein the first fixed part is fixed to the top plate and the first stretching part is connected to the first fixed part and the first connection part, so that the first shift structure is capable of moving the first mirror along the Z-axis direction by adjusting the first stretching part.

11. The probe device according to claim 10, further comprising:
a control module, coupled to the fixing base and the first shift structure, the control module adjusting the movement of the fixing base along the Z-axis direction according to a first image captured by the first camera through the first through hole, and/or adjusting the first shift structure to move the first mirror along the Z-axis direction.

12. The probe device according to claim 9, wherein the first camera is capable of moving along the Z-axis direction, the probe device further comprising:
a first connection part, connected to the first mirror and the first camera; and
a first shift structure, including a first fixed part and a first stretching part, wherein the first fixed part is fixed to the top plate and the first stretching part is connected to the first fixed part and the first connection part, so that the first shift structure is capable of moving the first mirror and the first camera along the Z-axis direction by adjusting the first stretching part.

13. The probe device according to claim 12, further comprising:
a control module, coupled to the fixing base and the first shift structure, the control module adjusting the movement of the fixing base along the Z-axis direction according to a first image captured by the first camera through the first through hole, and/or adjusting the first shift structure to move the first mirror and the first camera along the Z-axis direction.

14. The probe device according to claim 9, wherein the second side wall has a second through hole, the probe device further comprising:
a second camera, disposed outside the case and fixed to the top plate; and
a second mirror, which is disposed relative to the second camera with a second angle formed between a surface of the second mirror and the normal line of the second camera;
wherein the second mirror is capable of moving along the Z-axis direction so that the second camera captures images of the probe tip through the second through hole via the second mirror.

15. The probe device according to claim 14, further comprising:
a second connection part, connected to the second mirror; and
a second shift structure, including a second fixed part and a second stretching part, wherein the second fixed part is fixed to the top plate and the second stretching part is connected to the second fixed part and the second connection part, so that the second shift structure is capable of moving the second mirror along the Z-axis direction by adjusting the second stretching part.

16. The probe device according to claim 14, wherein the second camera is capable of moving along the Z-axis direction, the probe device further comprising:
a second connection part, connected to the second mirror and the second camera; and
a second shift structure, including a second fixed part and a second stretching part, wherein the second fixed part is fixed to the top plate and the second stretching part is connected to the second fixed part and the second connection part, so that the second shift structure is capable of moving the second mirror and the second camera along the Z-axis direction by adjusting the second stretching part.
